(19) United States
(12) Patent Application Publication
(10) Pub. No.: US 2012/0247397 A1
(43) Pub. Date: Oct. 4, 2012

(54) Remote control device for training animals via mechanical constriction on the collar

(76) Inventors: Matvey Lvovskiy, Brooklyn, NY (US); Alexander Falkovsky, North Woodmere, NY (US); Mikhail Lvovsky, Brooklyn, NY (US); Alexander Efros, Sanct Petersburg (RU)

(21) Appl. No.: 13/065,749

(22) Filed: Mar. 30, 2011

(51) Int. Cl. A01K 15/02; A01K 27/00

(52) U.S. Cl. 119/720; 119/859

(57) ABSTRACT

The proposed device allows for the remote control of a comprising mechanical collar simulating the rapid jerking motion of the leash on the neck of an animal subject for training purposes. The device is based on electromagnet fixed on the collar containing a solenoid and core. Under the current pulse the solenoid core is sharply ejected, the tip momentarily presses on the dog's neck as a result, there is a momentary constriction of the collar, similar to the pressure caused by the rapid jerking of a leash as performed in animal training. The remote control of the device is performed by use of radio signal coded pulses from the pulse transmitter that is held by the dog's owner in hands.

### BACKGROUND OF THE INVENTION

This is a mechanical device for the remote control and training of a canine. The device simulates the rapid jerking motion of the leash to give the user remote control of the collar. The device is universal and can be used for training other animal species.

It is well known that one of the cornerstones of dog training is the jerking movement of the leash, conveying to the dog (animal) a signal of an undesired behavior as well stimulating (guiding) the animal toward the desired action. This technique is an imitation of the natural behavior of a dominant dog controlling a submissive pack member or teaching a pup. As a result, dog trainers often have difficulty in establishing the same level of control via only verbal or sign communication without the implementation of the leash. To overcome this problem multiple remote control devices have been invented. Contemporary remote collars are based on delivering an electric shock or signal by way of electric current. These devices can be effective but are unnatural and manifest negative side effects.

The device proposed and described below circumvents the issues with current remote control training systems. This device gives the trainer control of an unleashed animal, while retaining a mechanism that is safe, humane, and mimics a natural setting as would the rapid jerking of the leash. This will attain the same type of development of reflexes in the animal that are achieved by implementing a leash.

One of the alternative devices used for training dogs is the electric shock collar, which subjects the dog to pulses of electrical current. Examples of such devices are US patents: U.S. Pat. No. 7,000,570, U.S. Pat. No. 7,559,291 and U.S. Pat. No. 7,685,971 can be cited as examples. Principal of operation for the devices mentioned is identical but they have different design and functional capabilities. Each of them includes one or another power supply, current transformer, receiving antenna, amplifier of radio signal. In addition, they contain separated electrodes of different configurations and electronic chip that provides connection of electrodes to a power source. The shock inducing elements are installed in the case fixed on the collar. While the collar is fastened on the dog, the electrodes are in contact with its body. When the electric pulse is applied to the electrodes the dog feels a shock or an unpleasant feeling and as a result it is forced to desired actions.

The described technique and apparatus mentioned in paragraph [0004] have several essential drawbacks:
a. Application of electric shock collars in training is unnatural and inhumane.
b. Application of electric Shocks on canines can elicit pain and fear responses*.
c. In extreme situations electric shock training can lead to seizures and convulsions*.
d. Electric shocks are not just a nuisance, but are really painful, receiving a shock may sometimes be perceived as a traumatic event by a dog *.
e. Shocked dogs are more stressful on the training grounds and in a park than control dogs*.
   *Schilder, Matthijs B. J., and Joanne A. M Van Der Borg. “Training Dogs with Help of the Shock Collar: Short and Long Term Behavioural Effects.” Applied Animal Behaviour Science 85.3-4 (2004): 319-34. Print.

Other methods and devices have been made in an attempt to influence canine barking behavior. One such method and device is described in patent U.S. Pat. No. 5,046,453. The do sated fluid is injected automatically on the surface of the fur if the dog begins to bark. Due to evaporation of the fluid the affected area is sharply cooled. As a result the dog feels discomfort and ceases to bark. Apart from the device's complexity such method of influence has nothing in common with the influence the dog gets under the leash. Therefore, none of the known and described methods and devices are able to provide the same level of control and safety as the proposed mechanical collar.

The device offered and described further is able to ensure maximum adequacy of control while the dog is on the leash or in case the collar is disconnected from the leash.

### SUMMARY OF THE INVENTION

The proposed device gives an animal trainer remote control of an animal subject. The remote control for the device sends radio signal coded pulses to a receiver located on the specifically designed collar that applies mechanical forces on the animal's neck.

The method of remote control by use of the proposed devised is based on the application of an electromagnet fixed on the specifically designed collar and containing solenoid and core. On the core face plane directed to the dog's neck the tip is fixed that is made of flexible material. When solenoid is activated by current pulses the core is sharply shifted so that the tip will press on the lower part of the dog's neck for a brief moment. At the same time, the collar constricts creating additional pressure then immediately springs back. In order to adjust for various sizes and characteristics of animals the device is able to produce different levels of force on the animal subject.

To perform the simulation of a rapid leash jerking motion remotely, i.e. without a direct connection between the trainer and animal via a leash attached to a collar. The proposed device including solenoid and core is supplemented with power source in form of storage batteries, receiving antenna, radio signal amplifier, controller and electronic relay that are installed in single case, fixed on the specifically designed collar. The radio signal pulses sensor is also included into device that is in the dog owner's or trainer's hand and carried out with some number of control elements that makes it possible to perform signals of various duration and force on the dog's neck in case an undesired behavior takes place. Using digital coding software it is possible to change the range of force applied on the collar depending on specific the features of the animal subject.

### BRIEF DESCRIPTION OF THE DRAWINGS

A detailed description of the device is followed by references to the accompanying drawings in which like elements are indicated by like references and numerals.

The proposed control unit that is fixed on the collar is shown on FIG. 1 A,B,C in various views illustrating design features.

FIG. 2 depicts the device's electric scheme.

FIG. 3 shows the control unit fixed on a neck of a dog.

### DETAILED DESCRIPTION OF PREFERRED EMBODIMENT OF THE INVENTION

The device consists of two autonomous parts that are fixed on the collar control unit providing force influence on the dog's neck and radio signal pulse sensor held in the hand of the trainer.

FIG. 1 (A,B,C) shows control unit for the force influence on the dog's neck 1 being fixed on collar 2 by means of a clasp (fastener) 3. Intended for the leash connecting the ring 4 is installed on the other side of collar. Rechargeable storage batteries 5, 6, solenoid 7, core 8 with a specified range of longitudinal movement restricted by a screw head 9 from one side and a cushion 10 that is fixed on the case 11 from the other side. The screw 12 that is made of non-magnetic material (brass for example) is screwed to the upper part of core 8 through the aperture in the case 11 upper part. The tip 13 that is made of flexible material (polymeric for example) is fixed on the screw head 12.

At the off position (see FIG. 1A) the core 8 is supported by spring 14. The core 8 is moved into on-position by solenoid 7 when its coil is under the operating current. The unit 1 also contains radio signal amplifier 15, controller 16, that is provided with reprogrammable memory and generating the output shaped pulses, and connected to the controller an output relay 17 that provides the solenoid switching to the storage batteries according with controller signals (see FIG. 1 C). The radio signal amplifier 15 is connected with receiving antenna 18 that is fixed on the collar 2 (see FIG. 1 B). To improve the radio signal reception by means of the antenna lengthening the latter is carried out in form of loop made of flexible multi-cored copper wire with insulation and installed on the collar's outer surface.

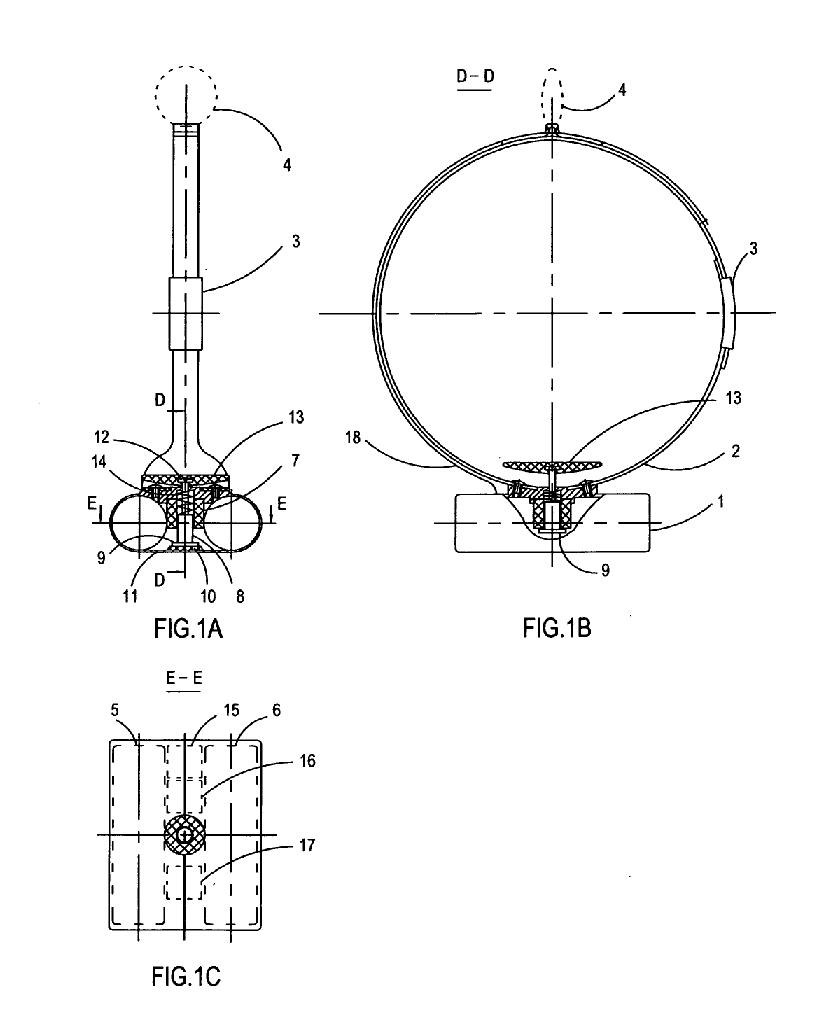

FIG. 2 shows device's electric scheme including elements of radio control required for switching on the solenoid. Besides the electric elements of unit 1, radio signal pulse transmitter 19 is included into the scheme as well. The latter is in the trainer's hand and it is carried out with three control buttons (F, G, H), for example, that makes it possible to provide three modes of force influence on the animal's neck (minimum, medium, maximum) in order to influence the animals behavior. The number of pulses, that are of identical duration and amplitude, and intervals between the pulses are different for each mode and in total create force influence on the animal's neck imitating the jerking of a leash with varying force.

The modes coding for force influence on dog's neck are carried out in radio signal pulses transmitter 19 by means of binary code that is modulating the wave carrier generated by the sensor at selected button pressing. The decoding is carried out by controller 16 including the decoder and reprogrammable memory with different modes of current pulses generation kept in it. In accordance with selected mode the controller generates the required number of output electric pulses with necessary duration by means of that the electronic relay 17 is connecting the storage batteries 5, 6 to solenoid 7. Under the current pulse the solenoid core 8 is sharply shifted so that the tip 13 performs the force influence on dog's neck over a period of time that is equal to the electric pulse duration. It should be noted that the list of force influence modes under consideration is one of the options. If necessary other options for force influence modes could be implemented with different numbers and durations of electric pulses generated by a controller supplementing the transmitter 19 by additional operating control means and appropriate software inserted into the controller's 16 reprogrammable memory.

The application of a single power pulse or a pack of similar pulses of the same amplitude makes it possible to simplify the device and save the storage batteries.

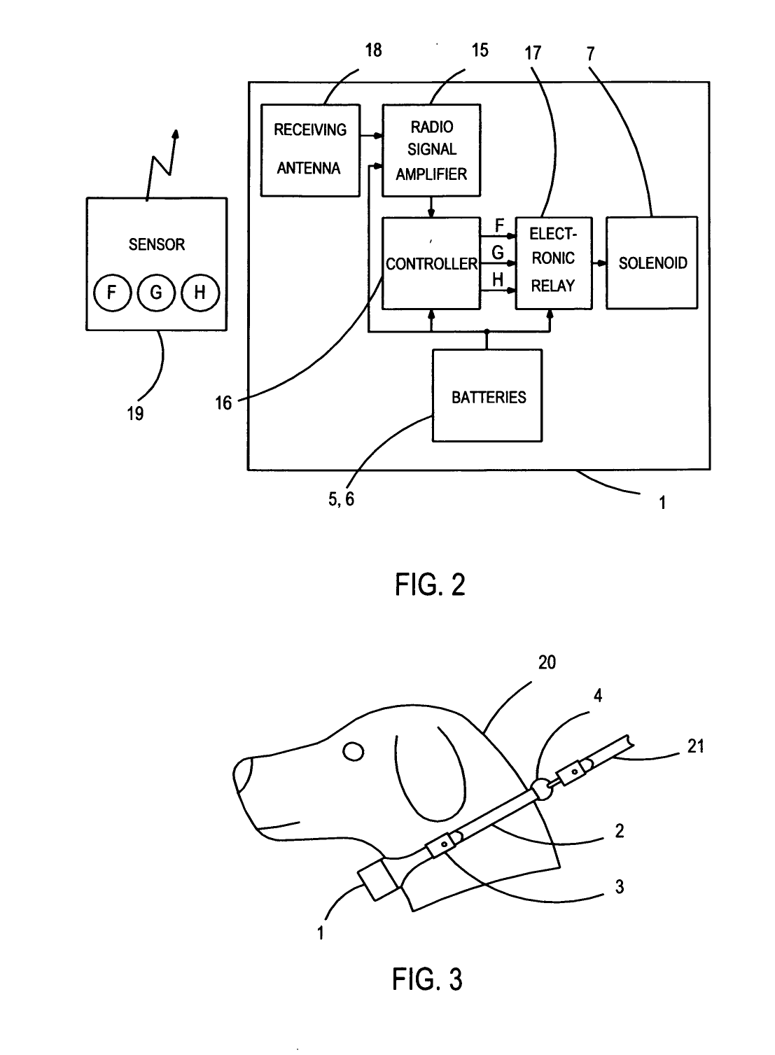

FIG. 3 shows the fixation of the unit 1 on dog's neck 20 by means of a clasp 3 on the collar 2. The collar is connected with the leash 21 through the ring 4.

### Advantages of the Invention

The proposed device circumvents the issues with current remote control training systems. This device gives the trainer control of the animal in the event that it is off the leash. While, retaining a mechanism that is safe, humane, and mimics a natural setting as would the rapid jerking of a leash. The device maintains the continuity of developed reflexes on the leash even when the animal is released from the leash. Due to this significant advantage it is possible to provide upgraded security for training, the animal subject, and it the surrounding environment. The device can facilitate training and increase the safety of guard dogs and official working dogs.

Additional advantages of the proposed device are its simplicity and consequently high reliability. Due to the device's efficiency it is operative for a long time with a single charging of storage batteries. This can be significant in cases where the animal is employed for an official function.

The proposed device has a “reprogramming” feature varying the set of remote commands. Thus, this device can be customized to the animal subject.

1. A remote control device for guidance of a dog by influence on a neck of the dog to perform remote guidance of the dog by a force influence on the neck that is similar to an influence caused by a sharp jerking of a leash connected to a collar comprising:
a control unit fixed on a dog collar for influencing a longitudinal movement force on the neck, wherein the control unit comprises a solenoid and a core; and
a radio signal pulses sensor held by a dog owner or trainer in hand.

2. The device as in claim 1, wherein the core is able to move in a longitudinal direction within a specified range, and wherein the core includes an upper end and the upper end of the core is provided with a tip made of flexible material, for example polymeric, that is directed toward the neck.

3. The device as in claim 1, wherein the control unit further comprises;
a power source; and
an electronic relay connecting the solenoid to the power source and a controller, wherein the controller has an input and an output and the output of the controller is connected to the electronic relay, and wherein the controller is configured to generate a single electric pulse or a specified pack of pulses depending on a signal.

4. The device as in claim 3, wherein the control unit further comprises a radio signal amplifier wherein the radio signal amplifier has an input and an output, wherein the output of the radio signal amplifier is connected to the input of the controller and the input of the radio signal amplifier is connected to a receiving antenna, wherein the receiving antenna is a loop made of flexible multi-cored copper wire with insulation and fixed on an outer surface of the dog collar where the control unit is installed.

5. The device as in claim 1, further comprising a sensor having at least one button configured to transmit a binary code when at least one button is pressed.

6. The device as in claim 3, wherein the controller is provided with a decoder.

7. The device as in claim 3, wherein the controller is carried out with reprogrammable memory.
